(19) United States
(12) Patent Application Publication
(10) Pub. No.: US 2007/0193954 A1
(43) Pub. Date: Aug. 23, 2007

(54) Method of preparing a separation matrix

(76) Inventor: Philippe Busson, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/592,807

(22) PCT Filed: Mar. 31, 2005
(86) PCT No.: PCT/SE05/00468

§ 371 Date: Sep. 14, 2006

(30) Foreign Application Priority Data
Apr. 5, 2004 (SE) 0400916-3

(51) Int. Cl. B01D 15/08; C08F 4/603

(52) U.S. Cl. 210/656; 427/2.11; 526/90

(57) ABSTRACT

The present invention is a method of preparing a separation matrix, which method comprises providing unsaturated monomers comprising one or more chromatography functionalities; contacting said monomer(s) with initiator and catalyst; performing controlled radical polymerisation of said monomers; and coupling of the resulting polymers to a base matrix. The controlled polymerisation technique may e.g. be ATRP, RAFT or NMP. The method allows preparation of well characterised ligands useful e.g. for HIC or any other kind of chromatography.

### TECHNICAL FIELD

The present invention relates to separation of molecules, such as proteins or other organic compounds, by adsorption to a separation matrix. More specifically, the present invention relates to a method of preparing such a separation matrix, which comprises a base matrix to which polymeric ligands have been attached.

### BACKGROUND

Chromatography embraces a family of closely related separation methods. The feature distinguishing chromatography from most other physical and chemical methods of separation is that two mutually immiscible phases are brought into contact wherein one phase is stationary and the other mobile. The sample mixture, introduced into the mobile phase, undergoes a series of interactions many times between the stationary and mobile phases as it is being carried through the system by the mobile phase. Interactions exploit differences in the physical or chemical properties of the components in the sample. These differences govern the rate of migration of the individual components under the influence of a mobile phase moving through a column containing the stationary phase. Separated components emerge in the order of increasing interaction with the stationary phase. The least retarded component elutes first, the most strongly retained material elutes last. Separation is obtained when one component is retarded sufficiently to prevent overlap with the zone of an adjacent solute as sample components elute from the column. The stationary phase is commonly comprised of a support or base matrix, also known as a carrier, to which ligands comprising functional i.e. interacting groups has been attached. Reference is commonly made to each kind of chromatography based on the principle of interaction utilised.

For example, ion exchange chromatography is based on charge-charge interactions. In anion exchange chromatography, negatively charged groups of the target compound will interact with positively charged ligands of a chromatography matrix. In cation exchange chromatography on the other hand, positively charged groups of the target compound will interact with negatively charged ligands of a chromatography matrix. Affinity chromatography is based on biological affinities between ligands and the target compound, such as enzyme-receptor interactions and antibody-antigen interactions. Protein A chromatography is a well known affinity chromatography method wherein the ligands comprising Protein A interact with the Fc fragment of target antibodies. Such Protein A ligands are conveniently prepared by recombinant DNA techniques. Interactions between a target compound and metal chelating groups present on the stationary phase are utilised in immobilised metal ion adsorption chromatography (IMAC), which is often used for the purification of proteins. Various chelating groups are known for use in IMAC, such as iminodiacetic acid (IDA) and nitrilotriacetic acid (NTA). In thiophilic adsorption chromatography, a divinyl sulphone-activated base matrix coupled with ligands that comprise a free mercapto group adsorb immunoglobulins in the presence of a lyotropic salt. More recently, it has been shown that the thioether of the mercapto group can be replaced by nitrogen or oxygen. In hydrophobic interaction chromatography (HIC), the separation matrix comprises hydrophobic groups. In reverse phase chromatography (RPC), a matrix which is completely hydrophobic is used.

A more recent kind of chromatography utilises stimulus-responsive polymers coupled to the base matrix. The stimulus-responsive polymers, also known as “intelligent polymers”, will undergo a structural and reversible change of their physicochemical properties when exposed to the appropriate stimulus. The stimulus can e.g. be a temperature change, light, magnetic field, electrical field and vibration. Stimulus-responsive polymers for use in chromatography have been suggested, see e.g. Palmgren, Ronnie et al: Stimulus-responsive polymers used in chromatographic separation” Abstracts of papers, 225^{th} ACS National Meeting, New Orleans, La., United States, CAPLUS accession no. 2003:179083 and patent application SE 0300791-1, wherein use of pH-responsive polymers in hydrophobic interaction chromatography is disclosed.

Further, U.S. Pat. No. 5,998,588 discloses an interactive molecular conjugate, which is e.g. a combination of a stimulus-responsive polymer and an affinity component. The disclosed polymers are preferably prepared by chain transfer-initiated free radical polymerisation of vinyl-type monomers. The molecular weight of the polymers can be controlled by varying the concentration of key reactants and the polymerisation conditions. However, the suggested polymerisation scheme will result in a relatively wide distribution of polymer chain lengths.

U.S. Pat. No. 4,581,429 (Commonwealth Scientific and Industrial Research Organization) relates to the preparation of polymers useful e.g. as surface coatings, such as high solids or solvent-free surface coatings, in adhesives, as plasticizers etc. More specifically, disclosed is a method which allows improved control of the growth steps of a polymerisation process. The improved control allows for example to obtain polymers with chain lengths below 200 monomer units, which prior to 1984 is stated to have been a problem in this field. The control of the growth steps is achieved by use of a free radical initiator, which comprises at least one carbon atom on which a free radical function can reside. More specifically, the initiator may comprise a group such as tertiary butyl, cyanoisopropyl, phenyl, methyl or the like. The disclosed method is known as controlled radical polymerisation (CRP), and enables preparation of polymer populations having a polydispersity index close to 1.

More recently, additional research has focused on the development of specific polymerisation methods with improved control of the product. Thus, reverse termination of the polymer chain has been utilised in nitroxide-mediated polymerisation (NMP) also known as stable free-radical polymerisation (SFRP), which method has been exploited especially in the synthesis of styrenic-based copolymers. NMP has been suggested e.g. for synthesis of functionalised three-dimensional macromolecules, such as nanoparticles, scaffolds for the encapsulation and chelating of a variety of guest molecules etc.

Reverse Addition-Fragmentation Transfer Polymerisation (RAFT) is another example of a more recent specific controlled radical polymerisation process, which has been disclosed especially in the context of nanoparticle manufacture.

U.S. Pat. No. 5,763,548 (Carnegie-Mellon University) discloses radical polymerisation with reversible termination by ligand transfer to a metal complex, which is known as Atom Transfer Radical Polymerisation (ATRP). More specifically, ATRP, which is a based on a redox reaction between a transition metal complex such as Cu(I)(II), provides living or controlled radical polymerisation of styrene, (meth)acrylates, and other radically polymerisable monomers. More specifically, using various simple organic halides as initiators and transition metal complexes as catalysts, such a living radical polymerisation provides polymers having a predetermined number average molecular weight and a narrow molecular weight distribution.

Further, Kim et al (Dong Jin Kim, Jin-young Heo, Kwang Soo Kim, and Insung S. Choi in Macromol. Rapid Commun. 2003, 24, 517-521: Formation of Thermoresponsive Poly(N-isopropylacrylamide)/Dextran Particles by Atom Transfer Radical Polymerisation) disclose grafting of polymers to surfaces that control biological interactions such as cell adhesion. More specifically, Kim et al disclose surface-initiated, aqueous atom transfer radical polymerisation via the attachment of a polymerisation initiator onto dextran microspheres and polymerisation of N-isopropylacrylamide. The resulting hybrid particles were about 250 μm in diameter and showed thermoresponsiveness. The suggested applications are surface adhesion modifiers, active drug targeting devices, biochemically triggered actuators or valves, support for cell culture and tissue engineering.

WO 01/09204 (Symyx Technologies) discloses a method of producing controlled-architecture polymers by living-type or semi-living type free radical polymerisation. More specifically, the disclosed architectured polymers are comprised of polyacrylamide repeating units having properties that are advantageous in electrophoretic separation systems, since the sieving capability of the partially branched or cross-linked polymer will be enhanced as compared to linear non-cross-linked polymers having the same repeating unit.

### BRIEF DESCRIPTION OF THE PRESENT INVENTION

One aspect of the present invention is a method of synthesising polymeric chromatography ligands of controlled molecular weight.

Another aspect of the invention is a method of synthesising polymeric chromatography ligands of controlled architecture, controlled composition and/or controlled functionality.

A further aspect of the invention is a method of synthesising a population of polymeric chromatography ligands of narrow polydispersity.

Other aspects and advantages of the present invention will appear from the detailed description that follows.

### BRIEF DESCRIPTION OF THE DRAWINGS

FIG. 1 provides a synthetic scheme for the preparation of ω-bromo end-functional polystyrenes by ATRP.

FIG. 2 shows a synthetic scheme for the preparation of ω-thiolate end-functional polystyrenes.

FIG. 3 shows a synthetic scheme for the coupling of ω-thiolate end-functional polystyrenes to activated agarose particles.

FIG. 4 shows a comparative elution profile of four proteins (myoglobin (1), ribonuclease A (2), α-lactalbumin (3), and α-chymotrypsinogen A (4)) on a prior art separation medium.

FIG. 5 shows a comparative elution profile of four proteins (as defined under FIG. 4) on the prior art separation medium High Sub Phenyl Sepharose™ 6FF (Amersham Biosciences, Uppsala, Sweden)

FIG. 6 shows the elution profile of four proteins (as defined under FIG. 4) on Gel 1 according to the invention, as described below.

### DEFINITIONS

The term “grafting from” is used herein for surface-initiated polymerisation of monomers.

The term “grafting to” is used for the coupling of a polymer to a surface.

The term “base matrix” means herein a carrier material, to which ligands can be coupled to provide a separation matrix.

The term a “separation matrix” means herein a base matrix to which ligands have been attached. The term “ligand” is used in its conventional sense in the field of chromatography, i.e. as pendent groups that comprise one or more functionalities capable of interaction with a target. In this context, the term “interaction” may be either a binding, often denoted adsorption, or a selective retardation.

The term “gel” is used herein for a separation matrix in gel form.

The term polymerisation “initiator” means herein a compound capable of acting as an atom transfer precursor in a chain polymerisation process.

The term polymerisation “catalyst” means herein a compound capable of acting as an atom transfer promoter in a chain polymerisation process.

The term “polydispersity” means molecular weight distribution, defined as weight average molecular weight divided by number average molecular weight (M_{w}/Mₙ).

### DETAILED DESCRIPTION OF THE INVENTION

A first aspect of the present invention is a method of preparing a separation matrix, which method comprises
(a) providing unsaturated monomers comprising one or more chromatography functionalities;
(b) contacting said monomer(s) with an initiator and a catalyst;
(c) performing a controlled radical polymerisation of said monomers;
(d) coupling of the resulting polymers to a base matrix.

The unsaturated monomers may be any monomers capable of undergoing controlled radical polymerisation, and are easily selected by the skilled person in this field. In one embodiment, in step (a), a mixture of monomers is provided, wherein at least one comprises at least one chromatography functionality. Consequently, the polymers resulting from step (c) may be copolymers, block polymers, such as random, block, gradient, star, graft or comb copolymers, and hyperbranched and dendritic polymers or copolymers. Illustrative examples of combinations of monomers to make copolymers are ethyl methacrylate-styrene and ethyl methacrylate-acrylamide. In one embodiment, the polymers resulting from step (c) are substituted.

In one embodiment of the present method, in step (a), a monomer which comprises one or more hydrophobic chromatography functionalities is provided. In this context, it is understood that the term “a monomer” refers to a kind of monomer. Thus, in an advantageous embodiment of the present method, step (a) comprises styrene monomers, and optionally one or more additional unsaturated monomers. In a specific embodiment, the monomers are selected from the group consisting of styrene, pentafluorostyrene, 4-methylstyrene, 4-tert-butylstyrene, 4-(trifluoromethyl)styrene and glycidyl vinylbenzyl ether. Consequently, in one embodiment of the present method, the separation matrix is a hydrophobic interaction (HIC) separation matrix.

Thus, in this case, each monomer unit will provide one hydrophobic functionality. However, step (a) may alternative comprise a mixture of two or more monomers. Other unsaturated monomers suitable to admix with the above are well known to the skilled person in this field and include for example hydroxyethyl methacrylate.

A specific case of a hydrophobic matrix is a matrix suitable for reverse phase chromatography (RPC), which uses a more strongly hydrophobic matrix than HIC. In this embodiment, some illustrative monomers are p-octyl styrene, p-cyclohexyl styrene, p-dodecyl styrene, and p-isopropyl styrene.

In an alternative embodiment, the monomers are selected so that the polymer resulting from step (c) is a stimulus-responsive polymer, as discussed above. Thus, in this embodiment, the monomers are for example N-isopropyl acrylamide (NIPAAm), and the resulting polymer is a temperature-responsive polymer. In another embodiment, the monomers are acrylic acid (AAc). In this embodiment, the polymers resulting from step (c) are pH-sensitive polymers. In an advantageous embodiment, the polymers resulting from step (c) are pH-responsive polymers comprising hydrophobic functionalities, such as disclosed in SE 0300791-1 (WO 2004/07831) (Amersham Biosciences, Uppsala, Sweden), which is hereby incorporated herein via reference. Consequently in one embodiment, the separation matrix comprises pH-responsive polymers.

As the skilled person in this field will understand, any other kind of chromatography functionality may equally well be present on the unsaturated monomers to provide other kind of separation matrices. Thus, the chromatography functionalities may be e.g. ion-exchange groups, affinity groups, IMAC groups, mixed mode ligands etc. For example, affinity ligands are suitably prepared from monomers such as acrylamido agmatine and acrylamido benzamidine; and ion exchange ligands may be prepared from tert-butyl acrylate or tert-butyl methacrylate, which is provided with ion-exchanging groups or protected ion-exchanging groups. The skilled person in this field can easily select the most suitable monomer(s) for the intended purpose, and can also include any additional steps such as deprotection, if required.

As appears from the above, step (c) is a controlled radical polymerisation of the unsaturated monomers. The concept of controlled radical polymerisation is well known in the field of polymer chemistry, and there are many textbooks that describe the general idea and various embodiments in detail, see e.g. “Handbook of radical polymerisation” 2002, Edited by Krzysztof Matyjaszewski and Thomas P. Davies, Wiley Intersciences, which is hereby incorporated herein via reference. In brief, as opposite to step polymerisation, controlled radical polymerisation (CRP) results in polymers with predetermined average molecular weights and narrow polydispersities. The growth in a CRP process proceeds rapidly to a final size, which is determined by the ratio of monomer:initiator. Thus, in one embodiment, the ratio of monomer:initiator is in the range between 1/5 and 1/200.

The present invention suggests for the first time the preparation of a separation matrix by the use of controlled radical polymerisation to manufacture a well-defined ligand, and to subsequently couple the resulting ligand to a base matrix by “grafting to” technique. Accordingly, the controlled radical polymerisation step allows the manufacture of polymeric chromatography ligands of controlled architecture, composition and functionality. As appears from the above, polymeric chromatography ligands have conventionally been prepared by “grafting from” techniques, wherein conventional step polymerisation is initiated at the surface of the base matrix. Such techniques have been commonly used, presumably since the exact composition of the ligands in conventional chromatography matrices has not been crucial. Consequently, the ease of manufacture has therefore favoured “grafting from” of step polymerised ligands. However, with the more recent development of novel kinds of polymeric ligands, such as stimulus-responsive polymers, a previously unknown problem has appeared, namely how to prepare more well-defined ligands. The more the exact nature of ligand matters to the actual chromatography performance, the more important this problem will become. For example, in HIC, the binding strength of a target compound will depend on the number of hydrophobic functionalities that can contact each target compound, and the binding strength needs to be controlled in order to allow efficient elution.

In one embodiment of the present method, step (b) comprises a catalyst and the initiator comprises an organic halide group. Illustrative initiators are alkyl halides, aryl halides and haloalkyl esters. One specific example of such a halide initiator is 1-phenylethyl bromide, which is commercially available e.g. from Aldrich. In a specific embodiment, the catalyst is a transition metal complex and the controlled polymerisation is atom transfer radical polymerisation (ATRP). The catalyst may be any transition metal compound which can participate in a redox cycle with the initiator and dormant polymer Chain, but which does not form a direct carbon-metal bond with the polymer chain. Thus, the transition metal complex can be selected from the group consisting of Cu(I)/Cu(II); Fe(II)/Fe(III); Ru(II)/Ru(III); Cr(II)/Cr(III); Mo(0)/Mo(I); Mo(II)/Mo(III); W(II)/W(III); Rh(III)/Rh(IV); Co(I)/Co(II); Re(II)/Re(III); Ni(0)/Ni(I); Mn(III)/Mn(IV); V(II)/V(III); Zn(I)/Zn(II); Au(I)/Au(II); and Ag(I)/Ag(II). In ATRP, the unsaturated monomers may be any radically polymerisable alkenes, such as (meth)acrylates, styrenes and dienes. A more detailed selection of suitable monomers and other conditions of ATRP is found in the above discussed U.S. Pat. No. 5,763,548, wherein ATRP is suggested for the manufacture of plastics, elastomers, adhesives etc.

In an advantageous embodiment, the method also comprises a step of providing the polymers with a group reactive with an activated base matrix. In one embodiment, this is achieved at an early stage by use of an initiator, which comprises such a group. In a second embodiment, this is achieved by use of a reactive monomer, which comprises such a group. In an alternative embodiment, this is achieved at a later stage by displacing a terminal halide of the polymer with a group reactive with an activated base matrix. This alternative embodiment is preferably performed as a step between the above-described step (c) and (d), and is advantageously used e.g. if step (c) is carried out with ATRP. Some examples of displacing groups comprise e.g. azido, amino, thio, hydroxyl, carboxylic acid or the like. Thus, in step (d), in a specific embodiment, polymers prepared by ATRP are easily coupled to a base matrix by converting the halide group obtained at the end of the polymer to a thiol group.

The polymers that comprise groups reactive with an activated base matrix are conveniently coupled to allyl-activated, epoxy-activated or thiol-activated base matrices according to well known methods. For a review of techniques suitable for coupling a polymer to a base matrix, see e.g. Immobilized Affinity Ligand Techniques, Hermanson et al, Greg T. Heirmanson, A. Krishna Mallia and Paul K. Smith, Academic Press, INC, 1992, which is hereby incorporated herein via reference.

In an alternative embodiment, the controlled polymerisation is nitroxide-mediated polymerisation (NMP). NMP has previously been suggested in the field of nanoparticles, where its versatility enables the production of three-dimensional macromolecular architectures suitable for the construction of defined materials. NMP is a reversible chain polymerisation process, which refers to reversible polymerisation-depolymerisation equilibria. The unsaturated monomers which are useful in NMP are any one of the above discussed, such as monomers of acrylate, methacrylate, styrene etc.

In yet an alternative embodiment, the controlled polymerisation is reverse addition-fragmentation transfer (RAFT) polymerisation. The RAFT polymerisation process has emerged as a robust and industry friendly route to produce living homopolymers, block and star polymers. The process involves a conventional free radical polymerization e.g. in the presence of a thiocarbonylthio compound. The unsaturated monomers which are useful in RAFT are any one of the above discussed, such as monomers of acrylate, methacrylate, styrene etc.

In one embodiment of the present method, the product of the polymerisation step (c) presents a polydispersity index (PDI) below about 1.4, preferably below about 1.3. Accordingly, the present invention provides a method of preparing a population of polymeric chromatography ligands, wherein the molecular weight distribution is substantially lower than in any alternative method suggested to this end.

The polymers resulting from step (c) may be of any suitable length, which is easily adjusted by the skilled person to a desired value. In one embodiment, the polymer size is in the range between 500 g/mole and 50,000 g/mole. The length of the polymer will depend on the desired properties of the separation matrix so prepared. Thus, it will be necessary to take into account both the frequency of each functionality, in case of a copolymer, and of the nature of the specific functional group. As the skilled person in this field will easily understand, if for example a HIC matrix is to be prepared, the length of the polymer will depend on the hydrophobicity of the functionalities as well as the presence of any other monomer. However, the essential feature of the present invention is not the actual amounts or monomer units used, but the design of a matrix that comprises well defined ligands. As mentioned above, the prior art step polymerisations used to synthesise polymeric ligands from a base matrix has not enabled the preparation of well-defined chromatography ligands.

The base matrix may be of any suitable form, such as particles, preferably essentially spherical particles, monoliths, membranes, filters, chips, capillaries or any other surface. The base matrix is preferably porous, in which case the ligands resulting from step (c) are coupled to both the external surfaces of the matrix and to the accessible pore surfaces. Thus, in one embodiment of the present method, the base matrix is comprised of porous particles of a diameter below about 100 μm, such as below about 90 μm. Thus, illustrative ranges of particle diameters are 0-100 μm, such as 20-80 μm, e.g. 30-50 μm or 50-70 μm. In an advantageous embodiment, the particles are porous.

The base matrix used in the present method may be made from an organic or inorganic material, such as organic polymers. Thus, in one embodiment, the base matrix is comprised of a cross-linked carbohydrate material, such as agarose, agar, cellulose, dextran, chitosan, konjac, carrageenan, gellan, alginate etc. Such a base matrix is easily prepared by the skilled person according to standard methods, such as inverse suspension gelation (S Hjertén: Biochim Biophys Acta 79(2), 393-39:8 (1964), which is hereby incorporated herein via reference. Alternatively, the base matrix is a commercially available products, such as Sepharose™ FF, Sepharose™ HP or Sephadex™ from Amersham Biosciences, Uppsala, Sweden, which provides many other base matrices equally suitable for use in the present method. Thus, in one embodiment of the present matrix, the support is a cross-linked polysaccharide. In a specific embodiment, said polysaccharide is agarose. Such carbohydrate materials are commonly allylated before immobilisation of ligands thereof. In brief, allylation can be carried out with allyl glycidyl ether, allyl bromide or any other suitable activation agent following standard methods.

In an alternative embodiment, the base matrix used in the present method is comprised of organic polymers, such as cross-linked synthetic polymers, e.g. styrene or styrene derivatives, divinylbenzene, acrylamides, acrylate esters, methacrylate esters, vinyl esters, vinyl amides etc. Such a base matrix is easily produced by the skilled person according to standard methods, see e.g. “Styrene based polymer supports developed by suspension polymerization” (R Arshady: Chimica e L'Industria 70(9), 70-75 (1988)), which is hereby incorporated herein via reference. Alternatively, the base matrix used in the present method is a commercially available polymeric matrix, such as Source™ from Amersham Biosciences AB, Uppsala, Sweden, which provides many other base matrices equally suitable for use in the present method.

Finally, polymeric ligands prepared by controlled radical polymerisation according to the invention may be coupled to an inorganic base matrix, such as silica, magnetic particles, carbon nanotubes etc. As the skilled person in this field will understand, some materials may require some routine adaption of the chemistry.

In an alternative embodiment, the separation matrix is a base matrix coated with polymers, which have been prepared by controlled radical polymerisation and subsequently grafted to said base matrix. Separation matrices of the coated kind are known as beads with extenders or with flexible arms; tentacle gels etc. Such a coating may be provided in order to spatially allow relatively large target compound to interact with the matrix, or to change the overall properties of a base matrix e.g. from hydrophobic to hydrophilic.

In a second aspect, the present invention relates to a separation matrix prepared as described above. In one embodiment, the present separation matrix is a hydrophobic interaction (HIC) matrix. In another embodiment, the polymers resulting from step (c) are stimulus-responsive polymers. In a specific embodiment, the polymers resulting from step (c) are pH-responsive polymers, such as pH-responsive polymers that comprise hydrophobic functionalities.

The separation matrix according to the invention may be used for isolation of biomolecules, such as proteins, such as monoclonal or polyclonal antibodies, peptides, such as dipeptides or oligopeptides, nucleic acids, such as DNA or RNA, peptide nucleic acids, viruses, cells, such as bacterial cells, prions etc. Alternatively, the separation matrix is useful to isolate organic molecules, such as drug candidates. In an alternative embodiment, the present separation matrix is useful to identify any one of the above discussed target compound, such as for diagnostic purposes. Thus, the products purified using the present separation matrix may be drugs or drug targets; vectors for use in therapy, such as plasmids or viruses for use in gene therapy; feed supplements, such as functionalized food; diagnostic agents etc. A specific application of a biomolecule purified according to the invention is a drug for personalized medicine.

The separation matrix according to the invention is also useful to purify a desired liquid from an undesired target compound, such as the above.

In a last aspect, the present invention relates to a chromatography column comprising a separation matrix as described above. The principles of liquid chromatography are well known to those of skill in this field and involves an adsorption step and commonly an elution step. Preferably, the separation matrix will be washed between said steps. As the skilled person in this field will realise, the nature of the buffers and conditions used will depend on the properties of the separation matrix and specifically on the polymeric ligands.

In one embodiment, the chromatography column according to the invention is of the kind known as a “limited-use” chromatography column, which in this context means a packed chromatography column which is most suitable for a limited number of uses, such as 1-10 times. In this context, most suitable means that for achieving a performance similar to that of the original product, a limited number of uses is obtainable. Such limited-use products are commercially known as “disposable products”.

### DETAILED DESCRIPTION OF THE DRAWINGS

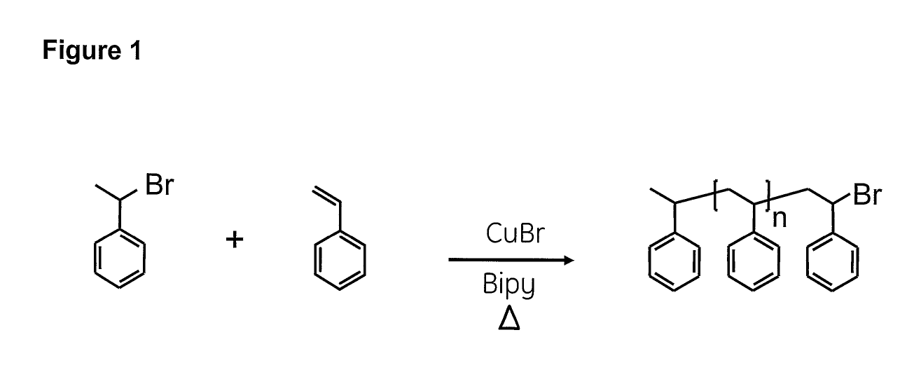

FIG. 1 provides a synthetic scheme for the preparation of ω-bromo end-functional polystyrenes by ATRP.

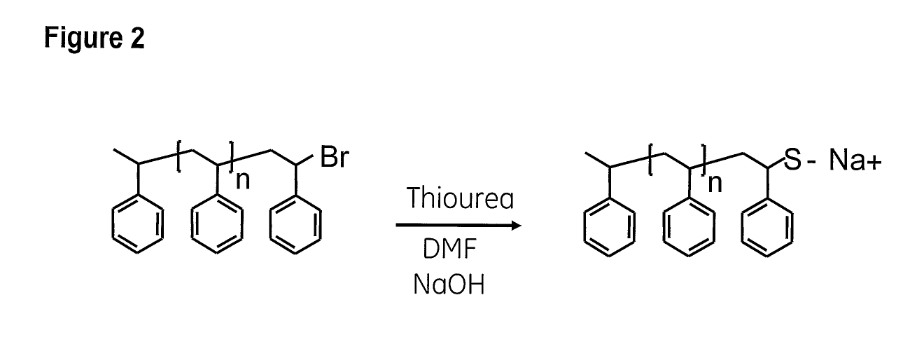

FIG. 2 shows a synthetic scheme for the preparation of ω-thiolate end-functional polystyrenes.

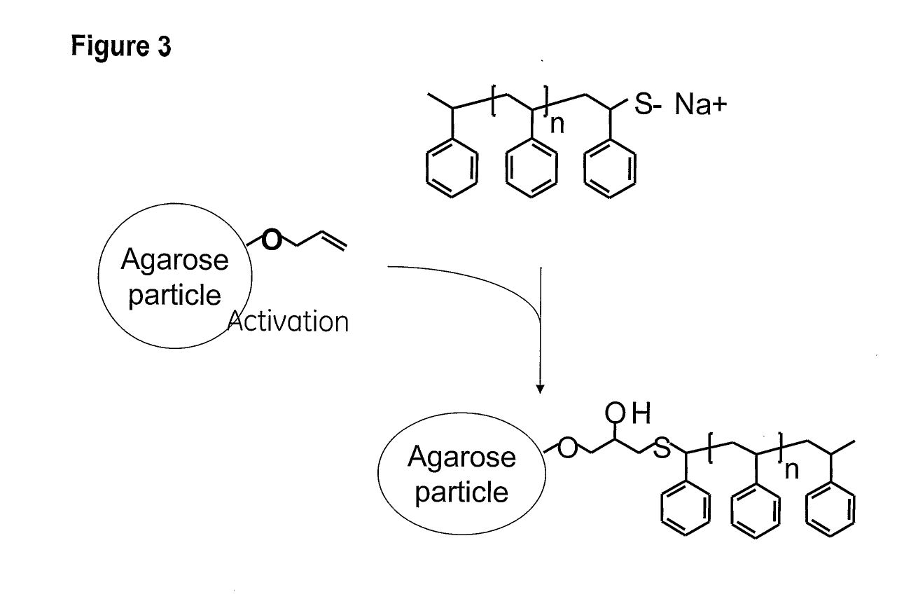

FIG. 3 shows a synthetic scheme for the coupling of α-thiolate end-functional polystyrenes to activated agarose particles.

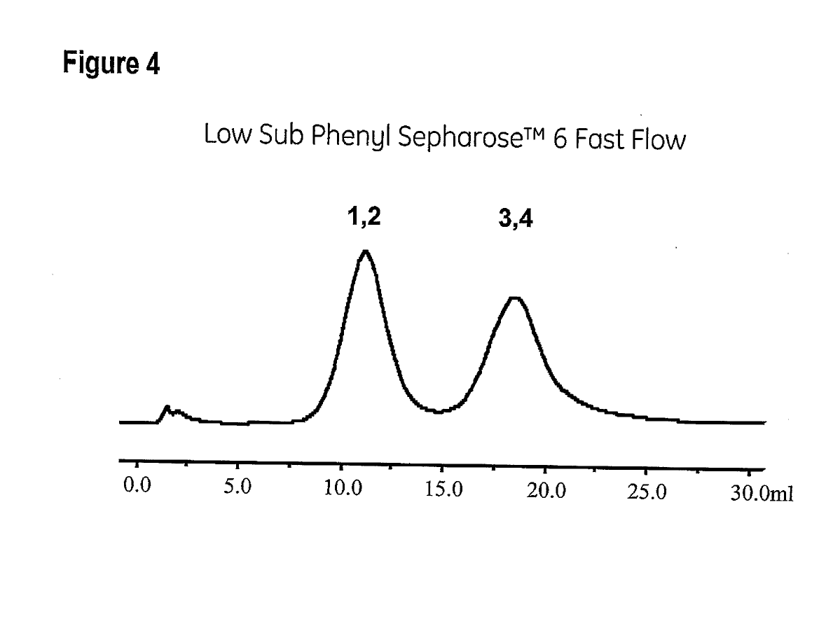

FIG. 4 shows a comparative elution profile of four proteins (myoglobin (1), ribonuclease A (2), α-lactalbumin (3), and α-chymotrypsinogen A (4)) on the prior art separation medium Low Sub Phenyl Sepharose™ 6FF (Amersham Biosciences, Uppsala, Sweden)

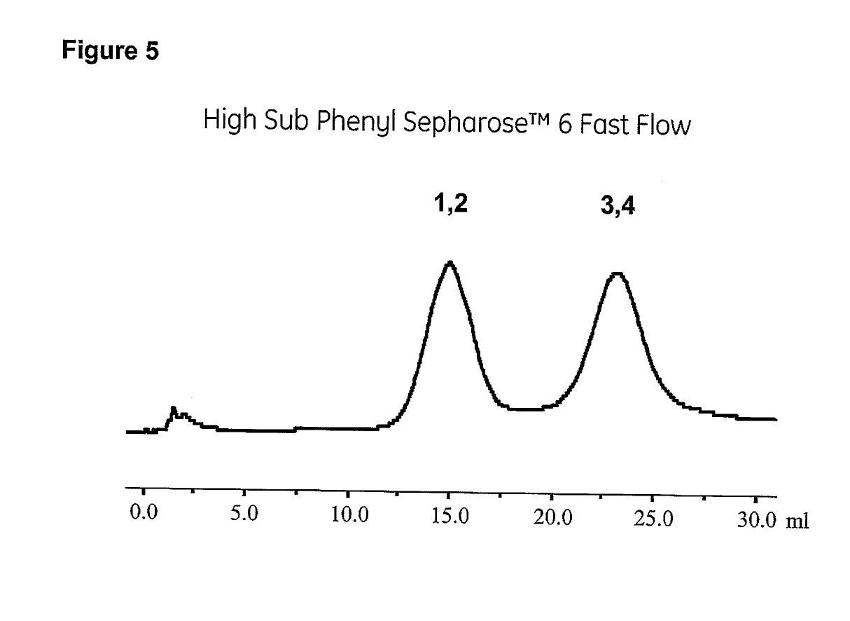

FIG. 5 shows a comparative elution profile of four proteins (as defined under FIG. 4) on the prior art separation medium High Sub Phenyl Sepharose™ 6FF (Amersham Biosciences, Uppsala, Sweden)

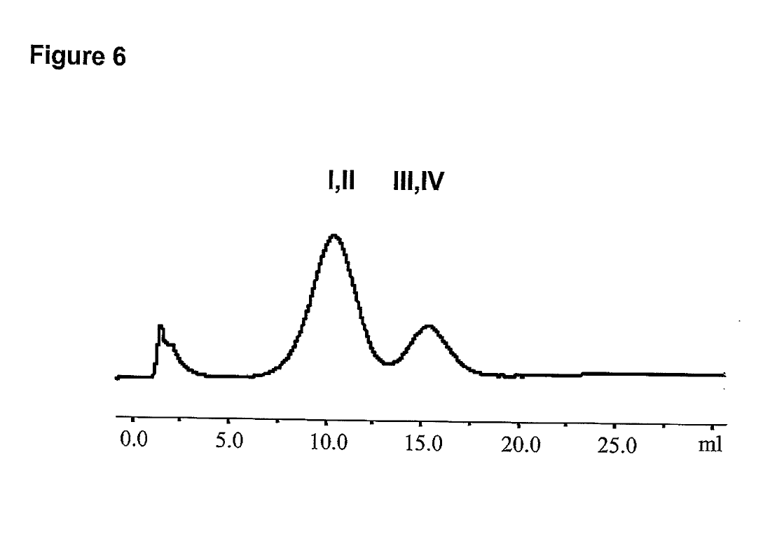

FIG. 6 shows the elution profile of four proteins (as defined under FIG. 4) on Gel 1 according to the invention.

More specifically, FIGS. 4 to 6 show an illustrative comparison of the elution profiles for four proteins (myoglobin, ribonuclease A, α-lactalbumin, and α-chymotrypsinogen A) using prior art separation media (Low Sub Phenyl Sepharose™ 6 Fast Flow and High Sub Phenyl Sepharose™ 6 Fast Flow, Amersham Biosciences, Uppsala, Sweden) (FIGS. 4 and 5, respectively) and one HIC medium prepared according to the present invention (FIG. 6). The samples were applied on the columns under identical conditions and elution was performed in all cases with a linear gradient of decreasing salt concentration.

### EXPERIMENTAL PART

The present examples are provided for illustrative purposes only, and should not be construed as limiting the scope of the present invention as defined by the appended claims.

### Example 1

### Synthesis of ω-Bromo End-Functional Polystyrene by ATRP

Styrene (St) (20.8 g, 200 mmol, 20 eq.), copper bromide (CuBr) (1.434 g, 10 mmol, 1 eq.) and 2,2′-dipyridyl (Bipy) (3.436 g, 22 mmol, 2.2 eq.) were mixed in a round-bottom flask under magnetic stirring. The solution was flushed with nitrogen or azote gas for 15 min. (1-bromoethyl) benzene (1-PeBr) (1.85 g, 10 mmol, 1 eq.) was added to the flask which was subsequently sealed. The reaction was warmed from room temperature to 110° C. and allowed to proceed for 5 hours. The reaction mixture was then cooled down and the polymer dissolved in CH₂Cl₂. The solution was passed through a short column of silica. The solvent was evaporated to give a viscous crude product. The crude product was dissolved in a minimum amount of CH₂Cl₂ and the polymer was obtained by re-precipitation of the CH₂Cl₂ phase in MeOH (volume of MeOH=10 times the volume of CH₂Cl₂). The precipitated polymer was filtered on a glass filter and dried under vacuum at 50° C.

Mn=2000 gmol⁻¹; PDI=1.26

### Example 2

### Synthesis of ω-Thiolate End-Functional Polystyrene

ω-bromo end-functional polystyrene from example 1 (4 g, 2 mmol, 1 eq.) was dissolved in DMF (30 ml) in a round-bottom flask under magnetic stirring. The solution was heated to 100° C. and flushed with nitrogen gas for 15 min. Thiourea (0.305 g, 4 mmol, 2 eq.) was added to the flask, which was subsequently sealed. The reaction was allowed to proceed overnight at 100° C. NaOH (0.16 g, 4 mmol, 2 eq.), dissolved in water (1 ml), was added to the flask and the reaction was allowed to proceed overnight at 95° C. The reaction mixture was then cooled down and CH₂Cl₂ was added. The organic phase was then extracted three times with a saturated aqueous solution of NaCl. The organic phase was then dried over MgSO₄ and filtered on a glass filter. The solvent was evaporated and the obtained crude product was dissolved in a minimum amount of CH₂Cl₂. The polymer was obtained by re-precipitation of the CH₂Cl₂ phase in MeOH (volume of MeOH=10 times volume of CH₂Cl₂). The precipitated polymer was filtered on a glass filter and dried under vacuum at 50° C.

Mn=2000 gmol⁻¹; PDI=1.28

### Example 3

### Gel 1: Coupling of ω-Thiolate End-Functional Polystyrene (Mn=2000 Gmol⁻¹) on activated Sepharose™ 6FF

Brominated Sepharose™ 6 Fast Flow was obtained following a well-known standard procedure. Thus, 5 ml (0.325 mmol allyl groups) of allylated Sepharose™ 6 Fast Flow with a loading of 65 μmol/ml gel were activated using bromine. After activation, the gel was washed with acetone and dried sucked.

ω-thiolate end-functional polystyrene from example 2 (3.25 g, 1.625 mmol, 5 eq. to allyl groups) was dissolved in acetone (10 ml) and triethylamine (0.33 g, 3.25 mmol, 10 eq. to allyl groups) was added to the solution. The activated gel and the polymer solution were mixed and the mixture was shaken overnight at 50° C. Gel 1 was then washed with acetone, ethanol and water until non-coupled polymer was removed.

### Example 4

### Chromatographic Evaluation for HIC

All experiments were performed at room temperature using an ÄKTA™ Explorer 100 chromatography system (Amersham Biosciences AB) equipped with a Unicorn 3.1 software.

1 to 2 ml of gel in a 5/5 HR column from Amersham Biosciences AB running at 1 ml/min was used. The method involves use of an A buffer of 2M (NH₄)₂SO₄+0.1M K Phosphate, pH 7, plus another B buffer of 0.1M K Phosphate, pH 7. The four proteins, myoglobin (0.5 mg/ml), ribonuclease A (2 mg/ml), α-lactalbumin (0.5 mg/ml) and α-chymotrypsinogen A (0.8 mg/ml), are mixed in the A buffer and applied to the column. The column is then run with A buffer for 2 ml and then a gradient going from 100% of A to 100% of B in 20 ml is applied.

The chromatogram of reference gels, Low Sub Phenyl Sepharose™ 6 Fast Flow and High Sub Phenyl Sepharose™ 6 Fast Flow, are shown in FIG. 4 and FIG. 5, respectively.

The chromatogram of Gel 1 made with a Sepharose™ 6 Fast Flow base matrix is presented in FIG. 6. The gel according to the invention works under the tested HIC conditions described above and present different elution profile than the prior art reference gels.

Legend for the chromatograms:

1: Myoglobin

2: Ribonuclease A

3: α-Lactalbumin

4: α-Chymotrypsinogen A

1. A method of preparing a separation matrix comprising:
a) providing unsaturated monomers comprising one or more chromatography functionalities;
b) contacting said monomer(s) with an initiator and a catalyst;
c) performing a controlled radical polymerisation of said monomers; and
d) coupling of the resulting polymers to a base matrix.

2. The method of claim 1 further comprising providing the polymers with a group reactive with an activated base matrix.

3. The method of claim 1, wherein in step (a), a monomer comprising one or more hydrophobic chromatography functionalities is provided.

4. The method of claim 3, wherein step (a) comprises styrene monomers, and optionally one or more additional unsaturated monomers.

5. The method of claim 1, wherein in step (b), the initiator comprises a halide group.

6. The method of claim 5, wherein the catalyst is a transition metal complex and the controlled polymerisation is Atom Transfer Radical Polymerisation (ATRP).

7. The method of claim 1, wherein the controlled polymerisation is nitroxide-mediated polymerisation (NMP).

8. The method of claim 1, wherein the controlled polymerisation is reverse addition-fragmentation transfer (RAFT) polymerisation.

9. The method of claim 1, wherein the product of the polymerisation step (c) presents a polydispersity index (PDI) below about 1.4, preferably below about 1.3.

10. The method of claim 1, wherein the base matrix comprises porous particles.

11. The method of claim 1, wherein the base matrix comprises a porous membrane.

12. A separation matrix prepared according to claim 1.

13. The separation matrix of claim 12, which is a hydrophobic interaction (HIC) matrix.

14. The separation matrix of claim 12, wherein the polymers resulting from step (c) are stimulus-responsive polymers.

15. A chromatography column packed with the separation matrix of claim 12.
